(19) United States
(12) Patent Application Publication
(10) Pub. No.: US 2010/0305937 A1
(43) Pub. Date: Dec. 2, 2010

(54) COPROCESSOR SUPPORT IN A COMPUTING DEVICE

(75) Inventor: Dennis May, London (GB)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: SYMBIAN SOFTWARE LTD., London (GB)

(21) Appl. No.: 12/063,262

(22) PCT Filed: Aug. 8, 2006
(86) PCT No.: PCT/GB2006/002960

§ 371 Date: Aug. 19, 2010

(30) Foreign Application Priority Data
Aug. 10, 2005 (GB) 0516454.6

(51) Int. Cl. G06F 9/455; G06F 9/445

(52) U.S. Cl. 703/26; 713/2

(57) ABSTRACT

Coprocessor support on a computing device is provided by means of external modules attaching themselves to the operating system (OS) kernel controlling the device at system boot time, with the modules registering themselves as valid coprocessor handlers. Threads initially execute with coprocessors disabled; the consequent exceptions caused by executing coprocessor instructions are then passed to the relevant registered handler. The technique can be used either to support installed coprocessors or to emulate absent coprocessors.

This invention describes a method of operating a computing device, and in particular to a method of operating a computing device whereby coprocessor support is provided in a computing device, and in particular to providing such support in an operating system for the computing device.

The term ‘computing device’ includes, without limitation, Desktop and Laptop computers, Personal Digital Assistants (PDAs), Mobile Telephones, Smartphones, Digital Cameras and Digital Music Players. It also includes converged devices incorporating the functionality of one or more of the classes of device already mentioned, together with many other industrial and domestic electronic appliances.

Computing devices operate under the control of a series of programmed instruction sequences, or code modules, executed by a central processing unit (CPU) in conjunction with input from the user of the device. There are two main classes of CPU in use in such devices:
Those used in complex instruction set computers (CISC) have a rich instruction set and are capable of performing complex computing operations extremely quickly; the CPUs used in desktop computers and servers from companies such as Intel and AMD are of this type. However, because of their complexity, CISC processors are relatively large and expensive to manufacture, and consume significant amounts of power.
Those used in reduced instruction set computers (RISC) have a minimal instruction set, and require complex computing operations to be built up out of sequences of simple instructions. However, such processors have the benefit that they are smaller and easier to manufacture; the higher manufacturing yields make them significantly less expensive to manufacture and they consume far less power than comparable CISC processors. For these reasons, RISC architectures are the ones generally used in modern battery-operated computing devices such as mobile telephones. One of the leaders in the design of RISC processors is ARM Ltd of Cambridge, England.

However, the necessity for RISC CPUs to build complex instructions out of sequences of relatively simple instructions can make them underperform CISC type CPUs when such complex instructions need to be performed frequently. RISC architects have sought to solve this problem in a number of ways, one of which is to allow coprocessors to be plugged into the main CPU in order to rapidly perform tasks that otherwise would complete too slowly. While coprocessors have also been used with CISC processors, the limited instruction set used in RISC devices means that the technology is considerably more important for boosting performance.

Coprocessors can be used to speed up operations in areas such as communications, graphics processing, multimedia, security and floating point arithmetic. For example, ARM™ architectures allow for up to 15 additional coprocessors to be used; examples of these are the Vector Floating Point (VFP), DSP and motion estimation units.

Most advanced computing devices are controlled by an operating system. An operating system (OS) is the software that controls the overall operation of the computing device it runs on. It is responsible for the management of the hardware—controlling and integrating the various hardware components in the system—as well as the software running on the device. Because of the number and complexity of the tasks which need to be controlled, most operating systems now operate in a multithreaded environment.

Using coprocessors in such an operating system presents particular difficulties. It is necessary when using a coprocessor in a multithreaded environment for the coprocessor state to be saved and restored, either during a context switch or on demand when a new thread attempts to access the coprocessor. The responsibility for doing this lies with the operating system, which therefore needs to have integrated coprocessor support.

However, the number and variety of coprocessors available for RISC based devices presents operating system producers with a conundrum. There are so many possible permutations of main processor and coprocessor combinations that it is not feasible for developers and providers of operating systems to provide different versions for an OS for all possible permutations; the practicalities of testing all the possible combinations alone would add orders of magnitude to the time it takes to launch a new version of such an operating system.

This invention seeks to provide a solution to the problems described above by means of pluggable coprocessor handlers, which can be added to an existing operating system to provide coprocessor support.

Supporting these handlers is the responsibility of the OS kernel, which is the central core of the OS, having complete control over all the rest of the hardware and software in the device.

According to a first aspect of the present invention there is provided a method of operating a computing device for supporting coprocessors present on the device, the method comprising causing the controlling software for the computing device to load one or more coprocessor support modules for supporting coprocessors at the point of startup of the computing device.

According to a second aspect of the present invention there is provided a method of emulating coprocessors on a computing device, the method comprising causing the controlling software for the computing device to load coprocessor support modules for this purpose at the point of startup of the computing device.

According to a third aspect of the present invention there is provided a computing device arranged to operate in accordance with a method of the first aspect or a method of the second aspect.

According to a fourth aspect of the present invention there is provided an operating system for causing a computing device to operate in accordance with a method of the first aspect or a method of the second aspect.

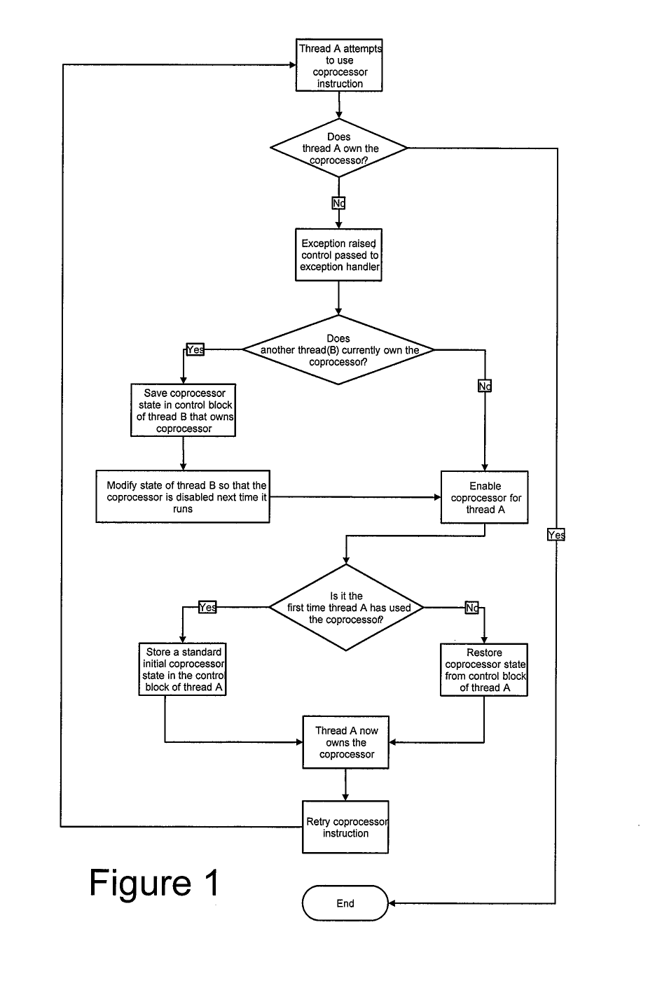

An embodiment of the present invention will now be described, by way of further example only, with reference to FIG. 1, which shows a method of enabling coprocessors in a computing device according to the present invention.

The kernel of an operating system for a computing device according to the present invention is arranged so that it can provide hooks by means of which external modules can attach themselves to the kernel at system boot time. These hooks can then register themselves as valid coprocessor handlers. Using these hooks, the external modules can reserve additional memory space in each thread in order to store data regarding the coprocessor state, and the modules can also be notified when a coprocessor state ‘save and restore’ is required. One additional external module is used for each coprocessor. In this way an agent external to the kernel is created that handles the activities necessary for context switching on the respective coprocessor.

This allows coprocessor support to be added in the same way as support for other hardware; device manufacturers can therefore build in coprocessor support without significant difficulty when they port an operating system to their hardware. This means that the OS provider does not have to take responsibility for including support for a large variety of multiple coprocessors.

The mechanism by which such pluggable coprocessor handlers are integrated into the device will now be described. The implementation described is for use with Symbian OS™ operating system, the global open industry standard operating system for advanced, data-enabled mobile phones. However, those skilled in the art will readily be able to adapt the implementation described below for other operating systems and other architectures.

IA-32 and some ARM CPUs have floating point coprocessors that contain a substantial amount of extra register state. For example, the ARM vector floating point (VFP) processor contains 32 words of additional registers. Naturally, these additional registers need to be part of the state of each thread so that more than one thread may use the coprocessor with each thread behaving as if it had exclusive access.

In practice, most threads do not use the coprocessor and so it is beneficial to avoid paying the penalty of saving the coprocessor registers on every context switch. In this example of the invention, this is achieved by using ‘lazy’ context switching. This relies on there being a simple method of disabling the coprocessor; any operation on a disabled coprocessor results in an exception. Both the IA-32 and ARM processors have such mechanisms:

IA-32 has a flag (TS) in the CR0 control register which, when set, causes any FPU operations to raise a ‘Device Not Available’ exception. The CR0 register is saved and restored as part of the normal thread context.

The ARM VFP has an enable bit in its FPEXC control register. When the enable bit is clear, any VFP operation causes an undefined instruction exception. The FPEXC register is saved and restored as part of the normal thread context.

Architecture 6 and some architecture 5 ARM devices also have a coprocessor access register (CAR). This register selectively enables and disables each of the 15 possible ARM coprocessors other than coprocessor CP15, which is always accessible. This allows the lazy context switch scheme to be used for all ARM coprocessors. If it exists, the CAR is saved and restored as part of the normal thread context.

The lazy context-switching scheme works as follows. Each thread starts off with no access to the coprocessor; that is, the coprocessor is disabled whenever the thread concerned runs. The following example explains the scheme followed, and is described with reference to FIG. 1.

As shown in FIG. 1, a thread, e.g. THREAD A, attempts to use a coprocessor. The coprocessor is disabled because THREAD A starts off with no access to the coprocessor, so an exception is raised and this is passed to an exception handler. The exception handler checks if another thread, e.g. THREAD B, currently has access to (‘owns’) the coprocessor. If so, the handler saves the current coprocessor state in the control block of THREAD B and then modifies the saved state of THREAD B so that the coprocessor will be disabled when THREAD B next runs. If there is not a thread, i.e. THREAD B using the coprocessor, then the exception handler does not need to save the state of the coprocessor in question.

Then, coprocessor access is enabled for the current thread, THREAD A, and the handler restores the coprocessor state from the control block of THREAD A —this is the state at the point when THREAD A last used the coprocessor. A standard initial coprocessor state will have been stored in the control block of THREAD A when THREAD A was created. If this attempt is the first time that THREAD A has used the coprocessor, this standard state will be loaded into the control block of THREAD A, as shown in FIG. 1. Therefore, THREAD A now owns the coprocessor.

The exception handler then returns, and the processor retries the original coprocessor instruction. This now succeeds because the coprocessor is enabled for THREAD A because it is now owned by THREAD A.

If a thread terminates while owning the coprocessor, the kernel marks the coprocessor as no longer being owned by any thread.

This scheme as shown in FIG. 1 ensures that the OS kernel only saves and restores the coprocessor state when necessary. If, as is quite likely, the coprocessor is only used by one thread, then its state is never saved. Of course, if for some reason the coprocessor were to be placed into a low power mode that would cause it to lose state, the state would have to be saved before doing so and restored when the coprocessor was placed back into normal operating mode. However, currently, coprocessors are not known to be in use having such a low-power mode.

Finally, it should be noted that coprocessor handlers can actually be used for two different purposes. One is to save and restore the coprocessor state as necessary to enable multiple threads to use the coprocessor. The other purpose for a coprocessor handler is to emulate a coprocessor that is not actually present.

It can be seen, therefore, that this invention provides significant advantages over the known art because it speeds up the development and distribution of operating systems for computing devices by avoiding the necessity to produce a separate version of the OS for all possible combinations of CPU and coprocessors.

In summary, therefore, this invention provides coprocessor support on a computing device by means of external modules attaching themselves to the OS kernel controlling the device at system boot time, with the modules registering themselves as valid coprocessor handlers. Threads initially execute with coprocessors disabled; the consequent exceptions caused by executing coprocessor instructions are then passed to the relevant registered handler. The technique can be used either to support installed coprocessors or to emulate absent coprocessors.

Although the present invention has been described with reference to particular embodiments, it will be appreciated that modifications may be effected whilst remaining within the scope of the present invention as defined by the appended claims.

1. A method of operating a computing device for supporting coprocessors present on the device, the method comprising causing the controlling software for the computing device to load one or more coprocessor support modules for supporting coprocessors at the point of startup of the computing device.

2. A method according to claim 1 wherein threads executed, scheduled or caused to run on the computing device initially do so with coprocessors disabled.

3. A method according to claim 2 wherein control of the computing device is passed by the controlling software to the appropriate loaded coprocessor support module when the device executes an exception associated with the said coprocessor, and in which the coprocessor support module thereupon enables the coprocessor and retries the instruction that caused the exception to be generated.

4. A method according to claim 3 wherein
a. the state of the coprocessor is saved by the coprocessor support module when an exception associated with the said coprocessor is executed by a thread which was not the last to use the coprocessor; and
b. the saved state is associated with the last thread to have used the coprocessor; and
c. the saved state is restored by the coprocessor support module when the thread with which it was associated uses the coprocessor.

5. A method of emulating coprocessors on a computing device, the method comprising causing the controlling software for the computing device to load coprocessor support modules for this purpose at the point of startup of the computing device.

6. A method according to claim 5 wherein control of the computing device is passed by its controlling software to the appropriate loaded coprocessor emulator module when the device executes the exception associated with the said coprocessor and in which the coprocessor emulator module thereupon emulates the instruction that caused the exception to be generated.

7. A method according to claim 6 wherein
d. the state of the emulated coprocessor is saved by the coprocessor support module when an exception associated with the said emulated coprocessor is executed by a thread which was not the last to use the emulated coprocessor; and
e. the saved state is associated with the last thread to have used the emulated coprocessor; and
f. the saved state is restored by the coprocessor support module when the thread with which it was associated uses the emulated coprocessor.

8. A computing device arranged to operate in accordance with a method as claimed in claim 1.

9. An operating system for causing a computing device to operate in accordance with a method as claimed in claim 1.

10. A computing device arranged to operate in accordance with a method as claimed in claim 5.

11. An operating system for causing a computing device to operate in accordance with a method as claimed in claim 5.
